(19) United States
(12) Patent Application Publication
(10) Pub. No.: US 2026/0371010 A1
(43) Pub. Date: Nov. 19, 2026

(54) Speaker Device

(71) Applicant: AAC Microtech (Changzhou) Co., Ltd., Changzhou City (CN)

(72) Inventors: Zhiwei Zhong, Changzhou (CN); Xiaodong Liu, Changzhou (CN); Xin Jin, Changzhou (CN); Wei Song, Changzhou (CN)

(21) Appl. No.: 19/278,749

(22) Filed: Jul. 23, 2025

Related U.S. Application Data
(63) Continuation of application No. PCT/CN2025/095168, filed on May 15, 2025.

(51) Int. Cl. H04R 9/02; H04R 1/06; H04R 7/12; H04R 7/18; H04R 9/04; H04R 9/06

(52) U.S. Cl. CPC H04R 9/025; H04R 1/06; H04R 7/127; H04R 7/18; H04R 9/046; H04R 9/06; H04R 2400/11

(57) ABSTRACT

The invention provides a speaker device which has a frame; a vibration system with a diaphragm and a voice coil; and a magnetic circuit system with a yoke, a main magnet stacked and fixed to a side of the yoke close to the diaphragm, and an auxiliary magnet. The speaker device further includes an elastic support member having a first connecting portion, a second connecting portion, and an elastic portion. The first connecting portion is fixed to a side of the auxiliary magnet away from the diaphragm along the vibration direction, the second connecting portion is fixed to a side of the diaphragm close to the magnetic circuit system along the vibration direction and is electrically connected to the voice coil. Compared with related technology, the speaker device of the invention has a long service life, saves installation space, and has excellent acoustic performance.

### TECHNICAL FIELD

The present invention relates to the field of electroacoustic transducer technology, particularly to a speaker device.

### BACKGROUND

With the development of electronic technology, portable consumer electronic products have become increasingly popular, such as mobile phones, handheld game consoles, navigation devices, or handheld multimedia entertainment devices. These electronic products generally use speaker devices for system feedback, such as mobile phone incoming call alerts, message alerts, navigation prompts, and game console vibration feedback. The speaker device used in mobile phones has become one of the most important components.

The speaker device in the prior art includes a frame, a vibration system fixed to the frame, and a magnetic circuit system driving the vibration system to vibrate. The vibration system includes a diaphragm fixed to the frame and a voice coil driving the diaphragm to vibrate and produce sound. The speaker device also includes an elastic connecting structure, with one end of the elastic connecting structure fixed to the frame and the other end extending to one side of the voice coil and electrically connected to the voice coil.

However, in the prior art speaker device, the force arm portion of the elastic connecting structure is all planar structure, which maintains connection during vibration by utilizing excess line length force arm shear deformation. The planar structure deformation force arm not only has internal stress but also has shear stress from deformation, resulting in poor vibration performance.

Therefore, it is necessary to provide a new speaker device to solve the above technical problems.

### SUMMARY

At least one of the objects of the present invention is to provide a sound generator with long service life, space-saving installation, and excellent acoustic performance.

To achieve the above purposes, the present invention provides a speaker device, which comprising:
a frame;
a vibration system comprising a diaphragm fixed to the frame and a voice coil configured to drive the diaphragm to vibrate and produce sound;
a magnetic circuit system comprising a yoke fixed to a side of the frame away from the vibration system, a main magnet stacked and fixed to a side of the yoke close to the diaphragm, and an auxiliary magnet stacked and fixed to the side of the yoke close to the diaphragm, wherein the auxiliary magnet and the main magnet are spaced apart to form a magnetic gap; and
an elastic support member located at an outer side of the voice coil. The elastic support member comprises a first connecting portion, a second connecting portion, and an elastic portion elastically connecting the first connecting portion and the second connecting portion. The first connecting portion and the second connecting portion are respectively disposed on opposite sides of the auxiliary magnet along a vibration direction. The first connecting portion is fixed to a side of the auxiliary magnet away from the diaphragm along the vibration direction. The second connecting portion is fixed to a side of the diaphragm close to the magnetic circuit system along the vibration direction and is electrically connected to the voice coil. The elastic portion is U-shaped, and the elastic portion is spaced apart from the auxiliary magnet.

As an improvement, the voice coil comprises a rectangular voice coil body and two first recessed portions formed by the voice coil body recessing toward each other from opposite sides thereof;
the main magnet comprises a rectangular main magnet body and two second recessed portions formed by the main magnet body recessing toward each other from opposite sides thereof; the voice coil body surrounds an outer peripheral side of the main magnet body, the first recessed portions are disposed in the second recessed portions; a projection of the second connecting portion along the vibration direction falls within the first recessed portions.

As an improvement, the auxiliary magnet comprises an annular auxiliary magnet body stacked and fixed to the yoke, and two protruding portions protruding toward each other from opposite sides of the auxiliary magnet body; the second connecting portion is spaced apart from the protruding portions along the vibration direction.

As an improvement, a recess is formed by the protruding portions recessing at a side away from the voice coil;
the elastic portion comprises a first elastic arm, a second elastic arm, and an arcuate portion fixedly connecting the first elastic arm and the second elastic arm; the first elastic arm is fixedly connected to the first connecting portion, the second elastic arm is fixedly connected to the second connecting portion, the arcuate portion is disposed in the recess and is spaced apart from the magnetic circuit system.

As an improvement, the elastic support member comprises two elastic support members, and openings of the two elastic portions face toward each other.

As an improvement, the speaker device further comprises an annular auxiliary pole piece, the auxiliary pole piece is stacked and fixed to a side of the auxiliary magnet close to the diaphragm, a projection of the auxiliary pole piece along the vibration direction completely overlaps with the main magnet, the auxiliary pole piece is provided with an avoidance slot recessing from a surface facing the diaphragm away from the vibration direction, the avoidance slot is spaced apart from the second elastic arm along the vibration direction.

As an improvement, the yoke comprises a yoke body fixed to the frame and an avoidance recess penetrating through the yoke body, the avoidance recess communicates with the recess;

the speaker device further comprises a sealing cover, the sealing cover and the first connecting portion are respectively disposed in the avoidance recess, the sealing cover is fixed to cover the recess.

As an improvement, the sealing cover comprises a seal body and a limiting portion formed by bending and extending from an end of the seal body away from the main magnet toward a direction close to the diaphragm; the seal body is disposed in the avoidance recess, the limiting portion is fixed to the auxiliary magnet.

As an improvement, the speaker device further comprises a protrusion formed by recessing at a side of the protruding portions away from the voice coil, the protrusion is located in the recess; the limiting portion is disposed in the protrusion.

As an improvement, the elastic support member comprises an elastic piece electrically connected to the voice coil and a transition assembly electrically connected to the elastic piece and fixed to a side of the auxiliary magnet away from the diaphragm along the vibration direction, the transition assembly comprises a conductive connecting member electrically connected to the elastic piece and a plastic seal injection-molded on the conductive connecting member, the elastic piece comprises the second connecting portion, the elastic portion and a connecting end portion electrically connecting the elastic portion to the conductive connecting member, the connecting end portion and the transition assembly form the first connecting portion.

As an improvement, the plastic seal is fixed in the avoidance recess, a side of the plastic seal close to the sealing cover abuts against the sealing cover.

As an improvement, the yoke further comprises protruding portions extending from sidewalls of the avoidance recess toward each other, the plastic seal and the protruding portions are integrally formed by injection molding.

Compared with the prior art, the speaker device of the invention, by arranging the elastic support member at the outer side of the voice coil; the elastic support member comprising a first connecting portion, a second connecting portion, and an elastic portion elastically connecting the first connecting portion and the second connecting portion; the first connecting portion and the second connecting portion being respectively disposed on opposite sides of the auxiliary magnet along the vibration direction, the first connecting portion being fixed to a side of the auxiliary magnet away from the diaphragm along the vibration direction, the second connecting portion being fixed to a side of the diaphragm close to the magnetic circuit system along the vibration direction and electrically connected to the voice coil; the elastic portion being U-shaped; the elastic portion being spaced apart from the auxiliary magnet; greatly reduces the stress received by the elastic portion during vibration compared to planar structures, significantly improves the vibration life of the elastic support member; meanwhile, the overall occupied planar space is greatly reduced, allowing for increased volume of other components, improving product acoustic performance; additionally, arranging the elastic support member at the outer side of the voice coil avoids the process difficulty of threading a three-dimensional elastic support member through the magnetic circuit; furthermore, since the main magnet's performance contribution is higher than the auxiliary magnet, the design at the outer side of the voice coil fully utilizes the outer space, maintains the integrity of the higher-contributing main magnet, resulting in better performance.

### BRIEF DESCRIPTION OF THE DRAWINGS

In order to more clearly explain the technical solutions in the embodiments of the present application, the following will briefly introduce the drawings required in the embodiments or exemplary technical descriptions. Obviously, the drawings in the following description are only for the application. In some embodiments, for those of ordinary skill in the art, without paying any creative labor, other drawings may be obtained based on these drawings, in which:

FIG. 1 is an isometric view of the speaker device provided by embodiment one of the invention;

FIG. 2 is an internal structural view of the speaker device provided by embodiment one of the invention;

FIG. 3 is an exploded view of the speaker device provided by embodiment one of the invention;

FIG. 4 is a cross-sectional view of the speaker device taken along line A-A in FIG. 1;

FIG. 5 is an isometric view of the auxiliary magnet of the speaker device provided by embodiment one of the invention;

FIG. 6 is an isometric view of the elastic portion of the speaker device provided by embodiment one of the invention;

FIG. 7 is a partially exploded view of the speaker device provided by embodiment one of the invention;

FIG. 8 is an isometric view of the speaker device provided by embodiment two of the invention;

FIG. 9 is a cross-sectional view of the speaker device taken along line B-B in FIG. 8;

FIG. 10 is an exploded view of the speaker device provided by embodiment two of the invention.

### DETAILED DESCRIPTION OF THE EMBODIMENTS

The following will be taken in conjunction with the accompanying drawings of embodiments of the present invention, The technical scheme in the embodiments of the invention is clearly and completely described, Obviously, the described embodiments are merely part of the embodiments of the present invention, and not all embodiments are based on the embodiments of the present invention, and all other embodiments attained by those of ordinary skill in the art without inventive effort are within the scope of the present invention.

### Embodiment One

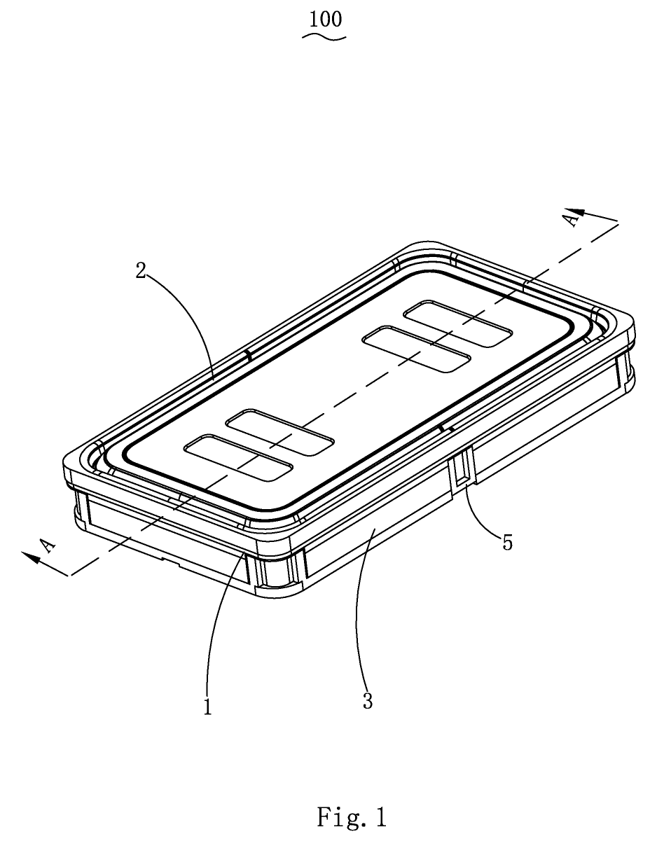

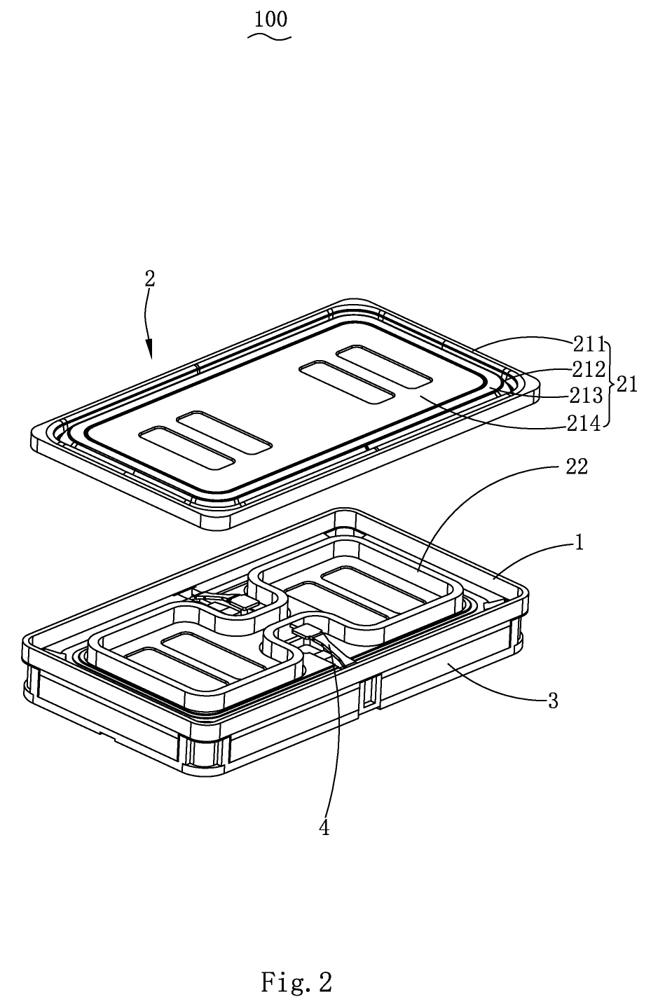

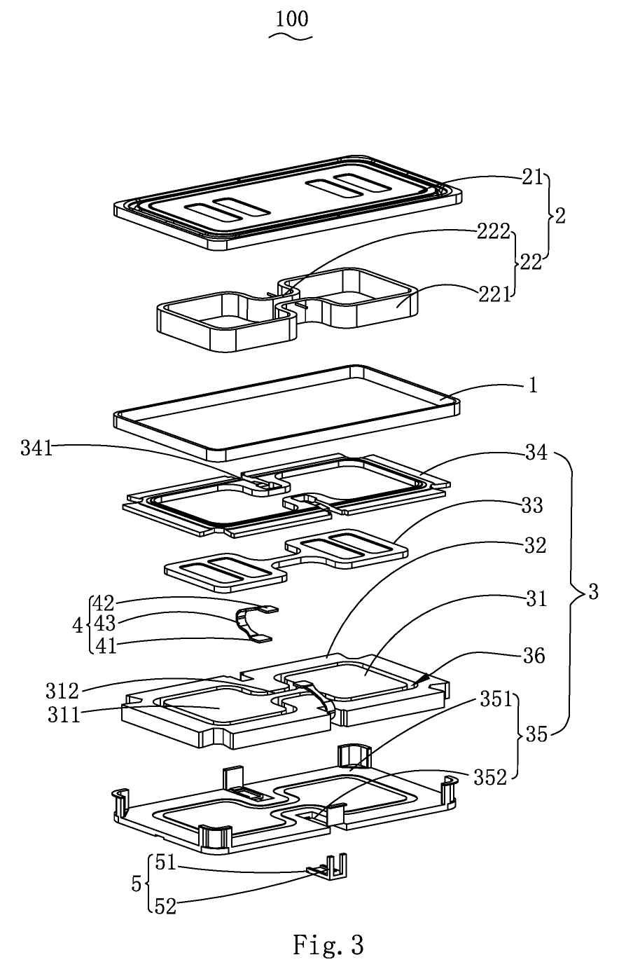

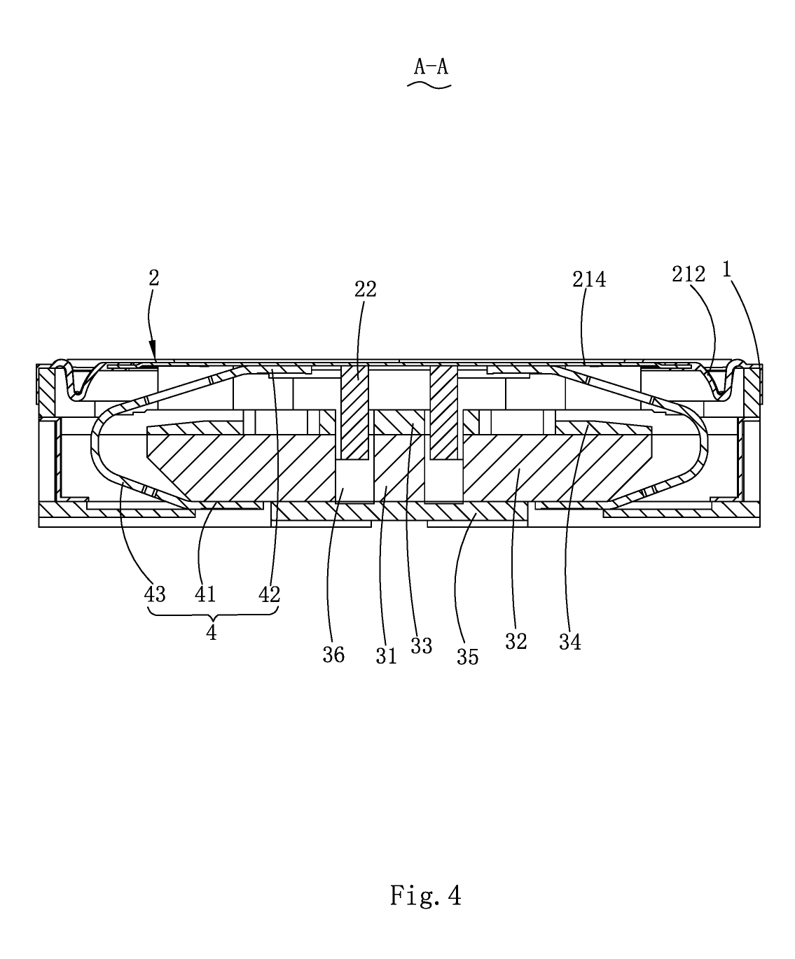

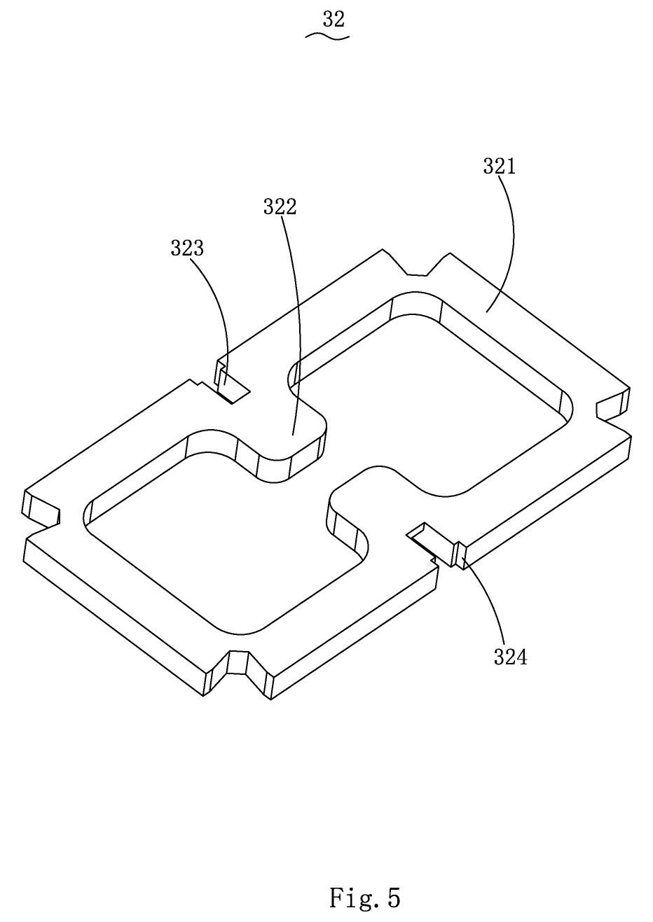

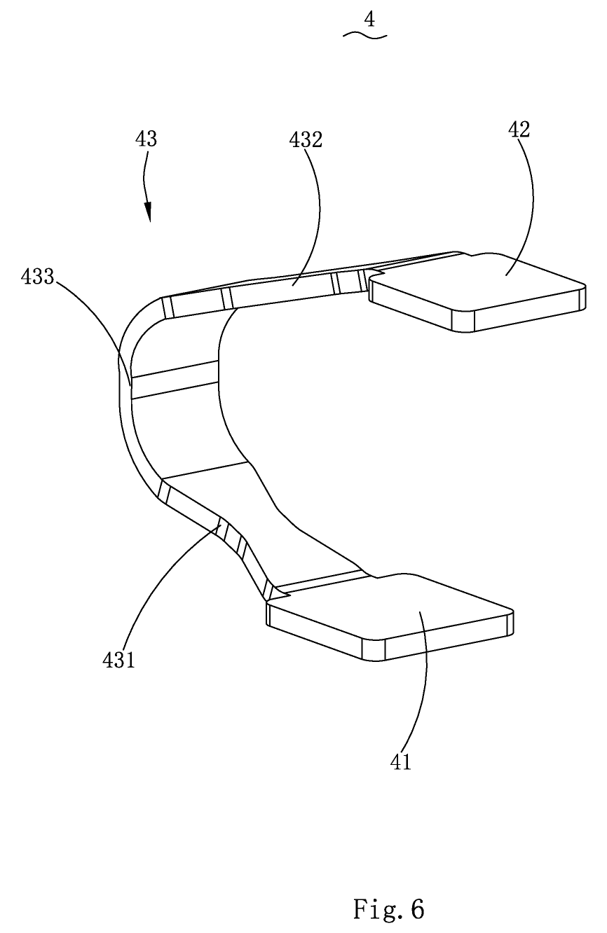

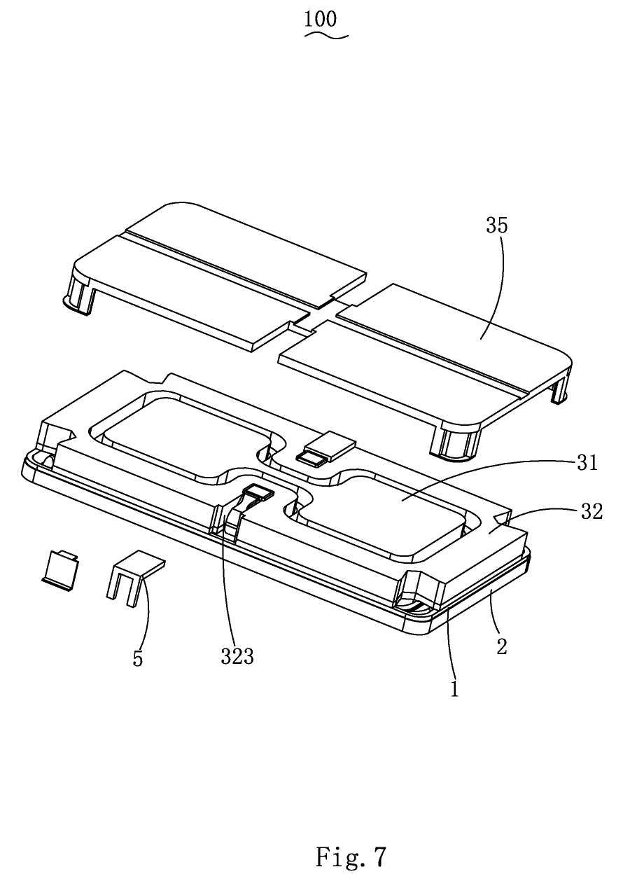

Referring to FIGS. 1-7, the embodiment of the invention provides a speaker device 100, comprising: a frame 1, a vibration system 2, and a magnetic circuit system 3.

The frame 1 is used to support and fix the vibration system 2 and magnetic circuit system 3, providing support performance.

The vibration system 2 comprises a diaphragm 21 fixed to the frame 1 and a voice coil 22 configured to drive the diaphragm 21 to vibrate and produce sound.

The magnetic circuit system 3 comprises a yoke 35 fixed to a side of the frame 1 away from the vibration system 2, a main magnet 31 stacked and fixed to a side of the yoke 35 close to the diaphragm 21, and an auxiliary magnet 32 stacked and fixed to the side of the yoke 35 close to the diaphragm 21; the auxiliary magnet 32 and the main magnet 31 are spaced apart to form a magnetic gap 36; the voice coil 22 is inserted in the magnetic gap 36. The magnetic gap 36 formed between the main magnet 31 and auxiliary magnet 32 drives the diaphragm 21 to vibrate and produce sound when the voice coil 22 is energized, improving the acoustic performance of the speaker device 100.

The speaker device 100 further comprises an elastic support member 4 located at the outer side of the voice coil 22. The elastic support member 4 comprises a first connecting portion 41, a second connecting portion 42, and an elastic portion 43 elastically connecting the first connecting portion 41 and the second connecting portion 42; the first connecting portion 41 and the second connecting portion 42 are respectively disposed on opposite sides of the auxiliary magnet 32 along the vibration direction, the first connecting portion 41 is fixed to a side of the auxiliary magnet 32 away from the diaphragm 21 along the vibration direction, the second connecting portion 42 is fixed to a side of the diaphragm 21 close to the magnetic circuit system 3 along the vibration direction and is electrically connected to the voice coil 22; the elastic portion 43 is U-shaped. The elastic portion 43 is spaced apart from the auxiliary magnet 32. This allows the first connecting portion 41 and second connecting portion 42 to open and close vertically during vibration of the speaker device 100, greatly reducing the stress received by the elastic portion 43 compared to planar structures, significantly improving the vibration life of the elastic support member 4. Meanwhile, the overall occupied planar space is greatly reduced, allowing for increased volume of other components, improving product acoustic performance; additionally, arranging the elastic support member 4 at the outer side of the voice coil 22 avoids the process difficulty of threading a three-dimensional elastic support member 4 through the magnetic circuit; furthermore, since the main magnet 31's performance contribution is higher than the auxiliary magnet 32, the design at the outer side of the voice coil 22 fully utilizes the outer space, maintains the integrity of the higher-contributing main magnet 31, resulting in better performance. Optionally, the elastic support member 4 is an FPC circuit board, providing good conductivity and elastic recovery effects.

Optionally, the yoke 35 may also have through holes to facilitate the first connecting portion 41 to be exposed outside the yoke 35 for soldering connection with external circuits to achieve electrical connection.

Specifically, the three-dimensional elastic conductive member is used in combination with a single voice coil 22, with the elastic conductive member arranged at the outer side of the voice coil 22. Various materials of the elastic conductive member, various three-dimensional force arm shapes, and corresponding various voice coil 22 shapes and magnetic circuit structures are included accordingly.

In this embodiment, the U-shaped structure also includes V-shaped and C-shaped structures, but is not limited to these. Any arc-shaped or similar arc-shaped structure that can provide elastic opening and closing movement along the vibration direction constitutes the U-shaped structure referred to in this embodiment, which connects the first connecting portion 41 and second connecting portion 42 that are not in the same plane, and provides elastic support force.

In this embodiment, the voice coil 22 comprises a rectangular voice coil body 221 and two first recessed portions 222 formed by recessing opposite sides of the voice coil body 221 toward each other. Optionally, the first recessed portions 222 are located on the long axis sides of the voice coil body 221.

The main magnet 31 comprises a rectangular main magnet body 311 and two second recessed portions 312 formed by recessing opposite sides of the main magnet body 311 toward each other; the voice coil body 221 surrounds the outer peripheral side of the main magnet body 311, the first recessed portions are disposed in the second recessed portions 312. A projection of the second connecting portion 42 along the vibration direction falls within the first recessed portions 222. Optionally, the second recessed portions 312 are located on the long axis sides of the main magnet body 311.

In this embodiment, the auxiliary magnet 32 comprises an annular auxiliary magnet body 321 stacked and fixed to the yoke 35, and two protruding portions 322 protruding toward each other from opposite sides of the auxiliary magnet body 321, wherein the second connecting portion 42 is spaced apart from the protruding portions 322 along the vibration direction.

In this embodiment, a recess 323 is formed by the protruding portions 322 recessing at a side away from the voice coil 22. The auxiliary magnet body 321 and the two protruding portions are respectively spaced apart from the main magnet body 311 and the two second recessed portions 312 to form the magnetic gap; the elastic portion 43 comprises a first elastic arm 431, a second elastic arm 432, and an arcuate portion 433 fixedly connecting the first elastic arm 431 and the second elastic arm 432; the first elastic arm 431 is fixedly connected to the first connecting portion, the second elastic arm 432 is fixedly connected to the second connecting portion, the arcuate portion 433 is disposed in the recess 323 and is spaced apart from the magnetic circuit system 3. This arrangement avoids the process difficulty of threading a three-dimensional elastic support member 4 through the magnetic circuit by placing the elastic support member 4 at the outer side of the voice coil 22; furthermore, since the main magnet 31's performance contribution is higher than the auxiliary magnet 32, the design at the outer side of the voice coil 22 fully utilizes the outer space, maintains the integrity of the higher-contributing main magnet 31, resulting in better performance. Optionally, the two protruding portions 322 are formed on the long axis sides of the auxiliary magnet body 321. Of course, in some structures, the two protruding portions 322 may be formed on the short axis sides of the auxiliary magnet body 321, producing the same effect.

In this embodiment, there are two elastic support members 4, and the elastic portions 43 of the two elastic support members 4 are respectively disposed in the two recesses 323, with the openings of the two elastic portions 43 facing toward each other along the short axis direction of the auxiliary magnet 32. The two elastic support members 4 can further enhance the elastic support capability of the diaphragm 21, thereby increasing the service life of the elastic support members 4.

In this embodiment, the speaker device 100 further comprises an annular auxiliary pole piece 34, which is stacked and fixed to a side of the auxiliary magnet 32 close to the diaphragm 21. A projection of the auxiliary pole piece 34 along the vibration direction completely overlaps with the main magnet 31. The auxiliary pole piece 34 is provided with an avoidance slot 341 recessing from a surface facing the diaphragm 21 away from the vibration direction, and the avoidance slot 341 is spaced apart from the second elastic arm 432 along the vibration direction. This facilitates the installation space for the elastic portion 43, while the auxiliary pole piece 34 can also improve the magnetic field performance of the auxiliary magnet 32.

In this embodiment, the speaker device 100 further comprises a main pole piece 33, which is stacked and fixed to a side of the main magnet 31 close to the diaphragm 21. The main pole piece 33 guides the magnetic field of the main magnet 31, thereby facilitating the enhancement of the overall magnetic field strength of the main magnet 31.

In this embodiment, the yoke 35 comprises a yoke body 351 fixed to the frame 1 and an avoidance recess 352 penetrating through the yoke body 351, the avoidance recess 352 communicates with the recess 323. The speaker device 100 further comprises a sealing cover 5, the sealing cover 5 and the first connecting portion 41 are respectively disposed in the avoidance recess 352, the sealing cover 5 is fixed to cover the recess 323. This facilitates the sealing cover 5 to pass through the avoidance recess 352 and be fixed to cover the recess 323, achieving sealing at the recess 323 position, which can provide overall protection. Meanwhile, part of the avoidance recess 352 covers the recess 323, while the first connecting portion 41 is installed on both sides of the recess 323, making it convenient for the first connecting portion 41 to connect with external power supply, conducting electrical signals through the first connecting portion 41, elastic portion 43, and second connecting portion 42 to the second connecting portion 42, facilitating the connection between the second connecting portion 42 and the voice coil 22 for power supply.

In this embodiment, the sealing cover 5 comprises a seal body 51 and a limiting portion 52 formed by bending and extending from an end of the seal body 51 away from the main magnet 31 toward a direction close to the diaphragm 21; the seal body 51 is disposed in the avoidance recess 352, the limiting portion 52 is fixed to the auxiliary magnet 32.

In this embodiment, the speaker device 100 further comprises a protrusion 324 formed by recessing at a side of the protruding portions 322 away from the voice coil 22, the protrusion 324 is located in the recess 323; the limiting portion 52 is disposed in the protrusion 324. This improves the installation and fixing effect of the limiting portion 52 while further enhancing its sealing performance.

In this embodiment, the diaphragm 21 comprises an annular suspension 212, a fastening portion 211 extending from the outer peripheral side of the suspension 212 toward the frame 1, a vibration portion 213 extending from the inner peripheral side of the suspension 212 away from the frame 1, and a dome 214 fixed to a side of the vibration portion 213 close to the magnetic circuit system 3; the voice coil 22 is fixed to a side of the dome 214 close to the magnetic circuit system 3; the second connecting portion 42 is fixed to a side of the dome 214 close to the magnetic circuit system 3.

### Embodiment Two

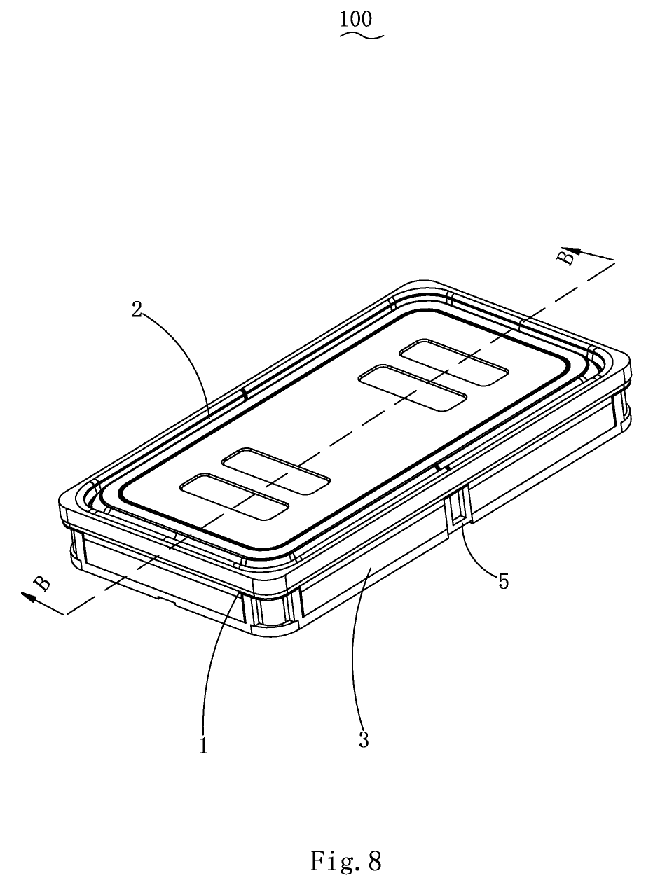

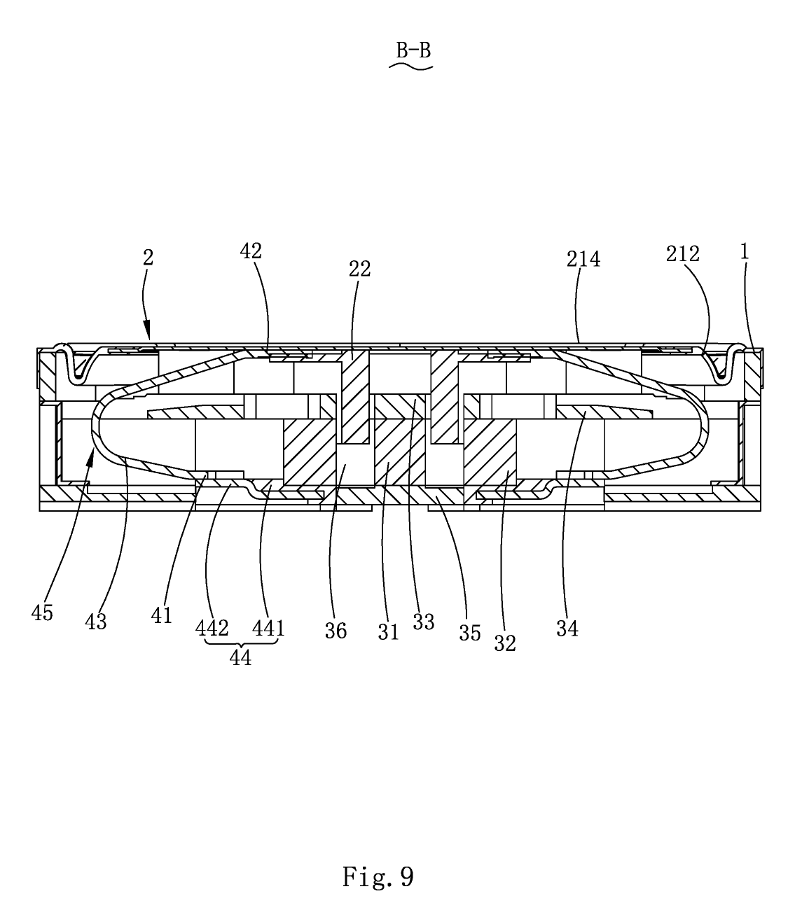

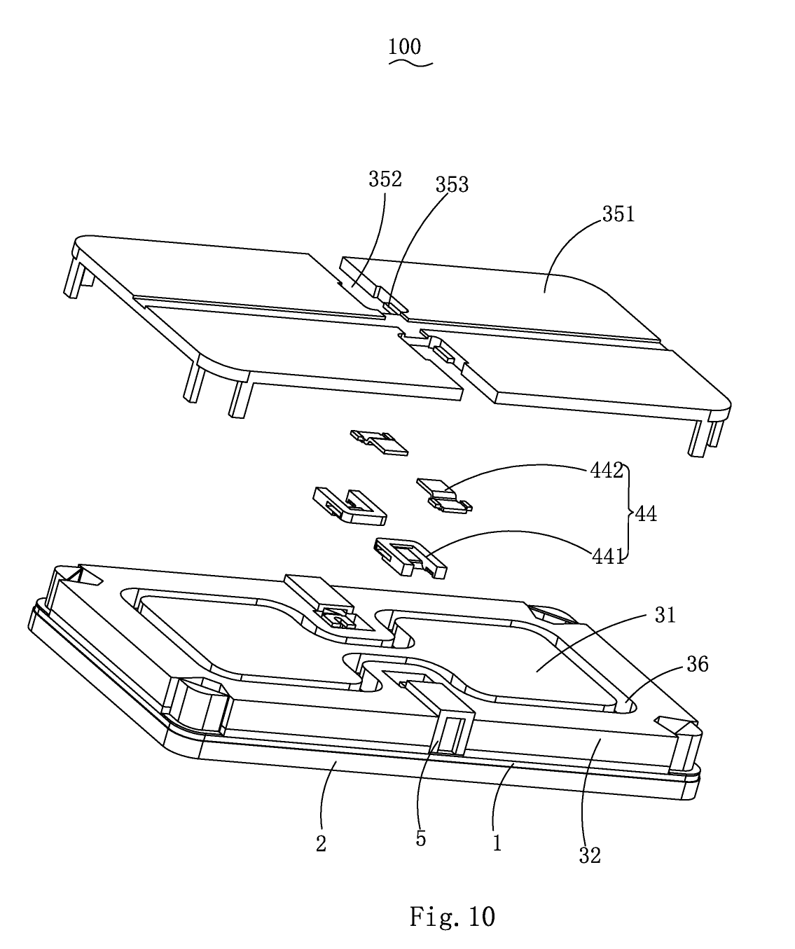

Referring to FIGS. 8-10, the second embodiment has basically the same structure as the first embodiment, with the difference being that in this embodiment, the elastic support member 4 comprises an elastic piece 45 electrically connected to the voice coil 22 and a transition assembly 44 electrically connected to the elastic piece 45 and fixed to a side of the auxiliary magnet 32 away from the diaphragm 21 along the vibration direction. The transition assembly 44 comprises a conductive connecting member 442 electrically connected to the elastic piece 45 and a plastic seal 441 injection-molded on the conductive connecting member 442. The elastic piece 45 comprises the second connecting portion 42, the elastic portion 43, and a connecting end portion electrically connecting the elastic portion 43 to the conductive connecting member 442, the connecting end portion and the transition assembly 44 form the first connecting portion 41.

In this embodiment, the plastic seal 441 is fixed in the avoidance recess 352, a side of the plastic seal 441 close to the sealing cover 5 abuts against the sealing cover 5. Installing the plastic seal 441 in the avoidance recess 352 and fixing the conductive connecting member 442 in the plastic seal 441 prevents signal interference caused by contact between the conductive connecting member 442 and the yoke 35. Connecting the conductive connecting member 442 to the first connecting portion of the elastic conductive member facilitates the extension of the conductive connecting member 442 to external power supply for powering the voice coil 22.

In this embodiment, the yoke 35 further comprises protruding portions 353 extending from sidewalls of the avoidance recess 352 toward each other, the plastic seal 441 and the protruding portions 353 are integrally formed by injection molding. This facilitates the plastic seal 441 to fill the avoidance recess 352, ensuring good overall sealing of the speaker device 100.

Compared with the prior art, the speaker device of the invention, by:
arranging the elastic support member at the outer side of the voice coil;
having the elastic support member comprise a first connecting portion, a second connecting portion, and an elastic portion elastically connecting the first connecting portion and the second connecting portion;
arranging the first connecting portion and the second connecting portion respectively on opposite sides of the auxiliary magnet along the vibration direction;
fixing the first connecting portion to a side of the auxiliary magnet away from the diaphragm along the vibration direction;
fixing the second connecting portion to a side of the diaphragm close to the magnetic circuit system along the vibration direction and electrically connecting it to the voice coil;
using a U-shaped structure for the elastic portion; and
keeping the elastic portion spaced apart from the auxiliary magnet;
greatly reduces the stress received by the elastic portion during vibration compared to planar structures, significantly improving the vibration life of the elastic support member;
significantly reduces the overall occupied planar space, allowing for increased volume of other components, improving product acoustic performance;
avoids the process difficulty of threading a three-dimensional elastic support member through the magnetic circuit by placing the elastic support member at the outer side of the voice coil, reducing process difficulty; and
maintains the integrity of the higher-contributing main magnet since its performance contribution is higher than the auxiliary magnet, with the design at the outer side of the voice coil fully utilizing the outer space, resulting in better performance.

The foregoing is merely illustrative of embodiments of the present invention, and it should be noted that modifications may be made to those skilled in the art without departing from the spirit of the invention but are intended to be within the scope of the inventio.

What is claimed is:

1. A speaker device, comprising:
a frame;
a vibration system comprising a diaphragm fixed to the frame and a voice coil configured to drive the diaphragm to vibrate and produce sound;
a magnetic circuit system comprising a yoke fixed to a side of the frame away from the vibration system, a main magnet stacked and fixed to a side of the yoke close to the diaphragm, and an auxiliary magnet stacked and fixed to the side of the yoke close to the diaphragm, wherein the auxiliary magnet and the main magnet are spaced apart to form a magnetic gap;
an elastic support member located at an outer side of the voice coil;
wherein
the elastic support member comprises a first connecting portion, a second connecting portion, and an elastic portion elastically connecting the first connecting portion and the second connecting portion;
the first connecting portion and the second connecting portion are respectively disposed on opposite sides of the auxiliary magnet along a vibration direction;
the first connecting portion is fixed to a side of the auxiliary magnet away from the diaphragm along the vibration direction;
the second connecting portion is fixed to a side of the diaphragm close to the magnetic circuit system along the vibration direction and is electrically connected to the voice coil; and
the elastic portion is U-shaped, and the elastic portion is spaced apart from the auxiliary magnet.

2. The speaker device as described in claim 1, wherein the voice coil comprises a rectangular voice coil body and two first recessed portions formed by the voice coil body recessing toward each other from opposite sides thereof;
the main magnet comprises a rectangular main magnet body and two second recessed portions formed by the main magnet body recessing toward each other from opposite sides thereof; the voice coil body surrounds an outer peripheral side of the main magnet body, the first recessed portions are disposed in the second recessed portions; a projection of the second connecting portion along the vibration direction falls within the first recessed portions.

3. The speaker device as described in claim 2, wherein the auxiliary magnet comprises an annular auxiliary magnet body stacked and fixed to the yoke, and two protruding portions protruding toward each other from opposite sides of the auxiliary magnet body; the second connecting portion is spaced apart from the protruding portions along the vibration direction.

4. The speaker device as described in claim 3, wherein a recess is formed by the protruding portions recessing at a side away from the voice coil;
the elastic portion comprises a first elastic arm, a second elastic arm, and an arcuate portion fixedly connecting the first elastic arm and the second elastic arm; the first elastic arm is fixedly connected to the first connecting portion, the second elastic arm is fixedly connected to the second connecting portion, the arcuate portion is disposed in the recess and is spaced apart from the magnetic circuit system.

5. The speaker device as described in claim 2, wherein the elastic support member comprises two elastic support members, and openings of the two elastic portions face toward each other.

6. The speaker device as described in claim 2, wherein the speaker device further comprises an annular auxiliary pole piece, the auxiliary pole piece is stacked and fixed to a side of the auxiliary magnet close to the diaphragm, a projection of the auxiliary pole piece along the vibration direction completely overlaps with the main magnet, the auxiliary pole piece is provided with an avoidance slot recessing from a surface facing the diaphragm away from the vibration direction, the avoidance slot is spaced apart from the second elastic arm along the vibration direction.

7. The speaker device as described in claim 2, wherein the yoke comprises a yoke body fixed to the frame and an avoidance recess penetrating through the yoke body, the avoidance recess communicates with the recess;
the speaker device further comprises a sealing cover, the sealing cover and the first connecting portion are respectively disposed in the avoidance recess, the sealing cover is fixed to cover the recess.

8. The speaker device as described in claim 7, wherein the sealing cover comprises a seal body and a limiting portion formed by bending and extending from an end of the seal body away from the main magnet toward a direction close to the diaphragm; the seal body is disposed in the avoidance recess, the limiting portion is fixed to the auxiliary magnet.

9. The speaker device as described in claim 8, wherein the speaker device further comprises a protrusion formed by recessing at a side of the protruding portions away from the voice coil, the protrusion is located in the recess; the limiting portion is disposed in the protrusion.

10. The speaker device as described in claim 9, wherein the elastic support member comprises an elastic piece electrically connected to the voice coil and a transition assembly electrically connected to the elastic piece and fixed to a side of the auxiliary magnet away from the diaphragm along the vibration direction, the transition assembly comprises a conductive connecting member electrically connected to the elastic piece and a plastic seal injection-molded on the conductive connecting member, the elastic piece comprises the second connecting portion, the elastic portion and a connecting end portion electrically connecting the elastic portion to the conductive connecting member, the connecting end portion and the transition assembly form the first connecting portion.

11. The speaker device as described in claim 10, wherein the plastic seal is fixed in the avoidance recess, a side of the plastic seal close to the sealing cover abuts against the sealing cover.

12. The speaker device as described in claim 10, wherein the yoke further comprises protruding portions extending from sidewalls of the avoidance recess toward each other, the plastic seal and the protruding portions are integrally formed by injection molding.
